(19) United States
(12) Patent Application Publication
(10) Pub. No.: US 2009/0167152 A1
(43) Pub. Date: Jul. 2, 2009

(54) Semiconductor lamp

(76) Inventor: Han-Ming Lee, Hsin Chu City (TW)

Correspondence Address: Han-Ming Lee, P.O. BOX 7-820, TAIPEI, TW

(21) Appl. No.: 12/005,981

(22) Filed: Dec. 31, 2007

(51) Int. Cl. H01J 1/62

(52) U.S. Cl. 313/503

(57) ABSTRACT

A semiconductor lamp is disclosed. The lamp comprises an electrode wire, light-emitting base material, electrode solenoid, a glass tube, silicon rubber layer and two insulated plugs. The outer rim of the electrode wire is in sequence covered by SiO₂ or light-emitting base material, and the external of the base material is provided with spiral electrode solenoid to form into light-emitting body. The two ends of the electrode wire and electrode solenoid are correspondingly connected to the glass tube having two sides fastened with electrode rods.

### BACKGROUND OF THE INVENTION

(a) Technical Field of the Invention

The present invention relates to semiconductor lamp, in particular, a lamp comprising an electrode wire, light-emitting base, electrode solenoid, glass tube, silicon rubber layers and two insulated plug.

(b) Description of the Prior Art

Conventional light bulb generally has two conductive legs bridging tungsten within a glass shell, and electric current causes the tungsten to produce light and heat. For this conventional bulb structure, the flowrate of the current determine the brightness of the light bulb. Under the recent trend of energy shortage and the heat generated by the light bulb, more electric current is used in order to maintain the temperature of the room by increasing the power of air conditional system.

### SUMMARY OF THE INVENTION

The primary purpose of the present invention is to provide a semiconductor, wherein the silicon rubber layer with fluorescent powder is added to provide colored light source or color change effects.

A further object of the present invention is to provide a semiconductor lamp, wherein he electrode wire is tubular conductive body.

Yet still a further object of the present invention is to provide a semiconductor lamp, wherein the internal of the tubular body is mounted with heat dissipation aluminum or copper wire.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the semiconductor lamp in accordance with a preferred embodiment of the present invention.

FIG. 2 is a perspective exploded view of the semiconductor lamp of the present invention.

FIG. 3 is a perspective partially sectional view of the present invention.

FIG. 4 is a sectional view of the present invention.

FIG. 5 is a schematic view of another preferred embodiment of the present invention.

### DETAILED DESCRIPTION OF THE PREFERRED EMBODIMENTS

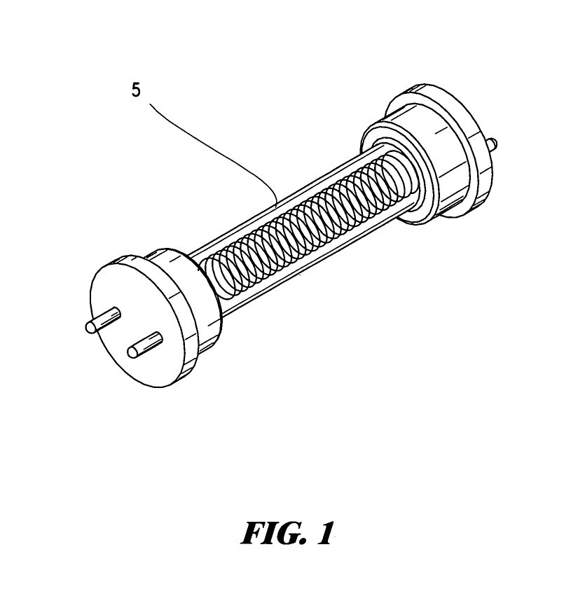

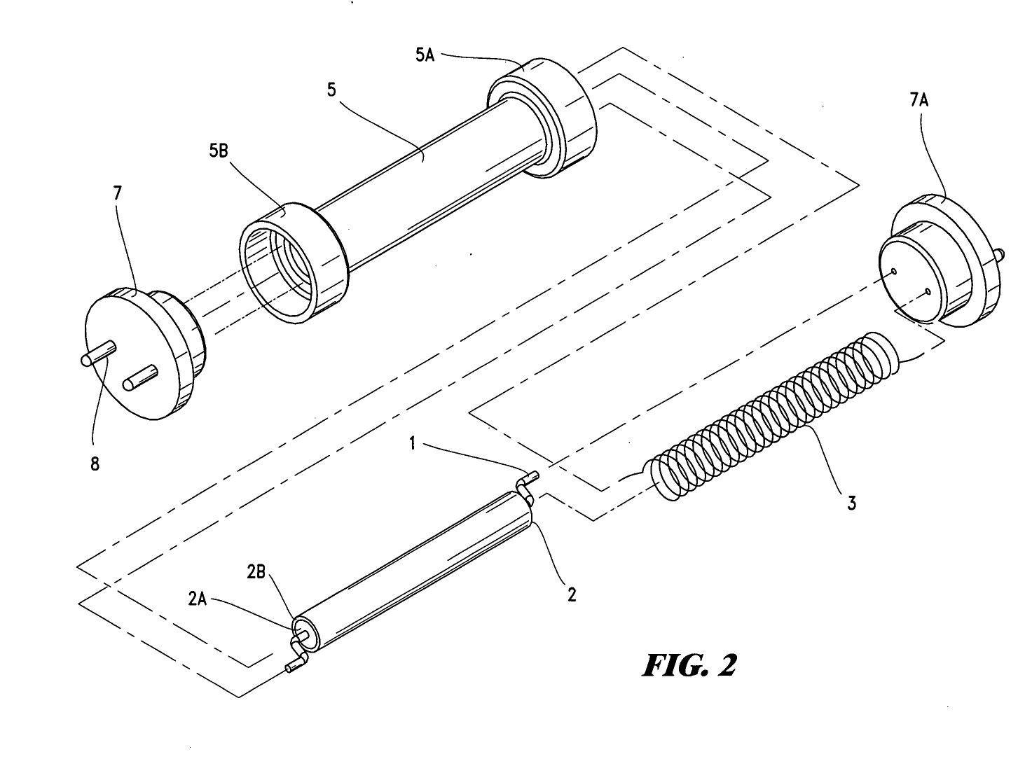

Referring to FIGS. 1 to 4, there is shown a semiconductor lamp comprising an electrode wire 1, light-emitting base material 2, electrode solenoid 3, a glass tube 5, silicon rubber layer 6 and two insulated plugs 7,7A. The electrode wire 1 is made from conductive copper material and the light-emitting base material 2 includes two circular layers in sequence covering the external rim of the electrode wire 1. The inner layer 2A is made from material selected from SiO₂, Al₂O₃, or TiO₂ or base material of similar category. The outer layer 2B is made from material selected from the group consisting of gallic nitrides family (AlN, InN), gallic phosphate, gallic arsenide, Indium phosphate third and forth family compounds. The electrode solenoid 3 is conductive copper material and of spiral shape for mounting onto the external rim of the light-emitting base material 2 forming into a light-emitting body. The glass tube 5 is a glass housing or shell having two openings with outwardly extended circular seats 5A, 5B for the light-emitting body to be inserted into the inner diameter of the glass tube 5. The silicon rubber layer 6 is a silicon rubber adhesive which is a transparent or with fluorescent powder for filing the gap formed between the light-emitting body and the glass tube. The two insulated plugs 7, 7A are insulated stepped-like seat body having a larger diameter face mounted with two corresponding conductive rods 8 for connection with a power supply, and a smaller diameter face is for the fastening to a circular seat 5A, 5B. The diameter faces of the individual rim are provided with two through hole for the passage of the electrode wire 1 and one end of the electrode solenoid to connect with two conductive rods 8. This is the main features of the present invention.

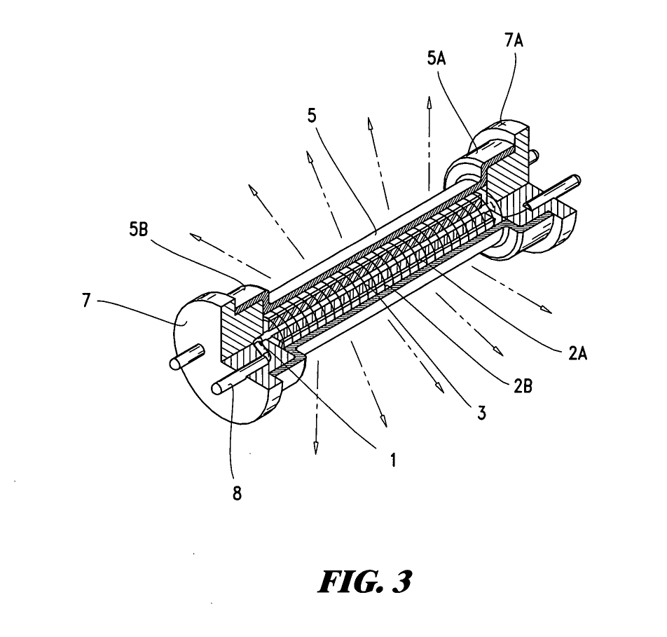

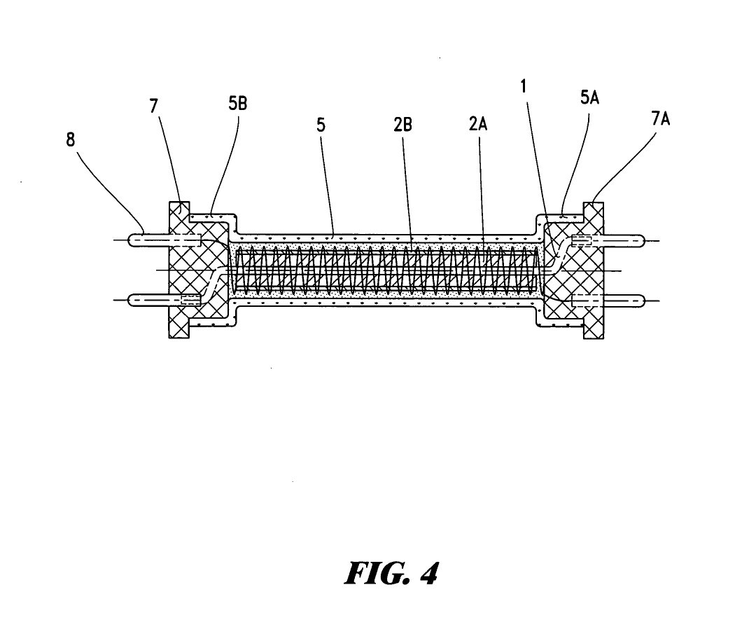

In accordance with one preferred embodiment of the present invention, referring to FIGS. 3 and 4, the external rim of the electrode wire 1 is in sequence covered by a layer of semiconductor light-emitting base material 2. The spiral electrode solenoid 3 at the outer layer is passed through by electromagnetic excited light-emitting base material and therefore the semiconductor produces excited light. In combination with the silicon rubber containing fluorescent powder to provide a multi-color light sources contrast and modification, the current that exhausted is about 1/10 to ⅛ of the conventional bulb or about ½ of the day light bulb. Further, the longevity of the semiconductor lamp is 50,000 hours above. The lamp does not generate heat and is environment friendly.

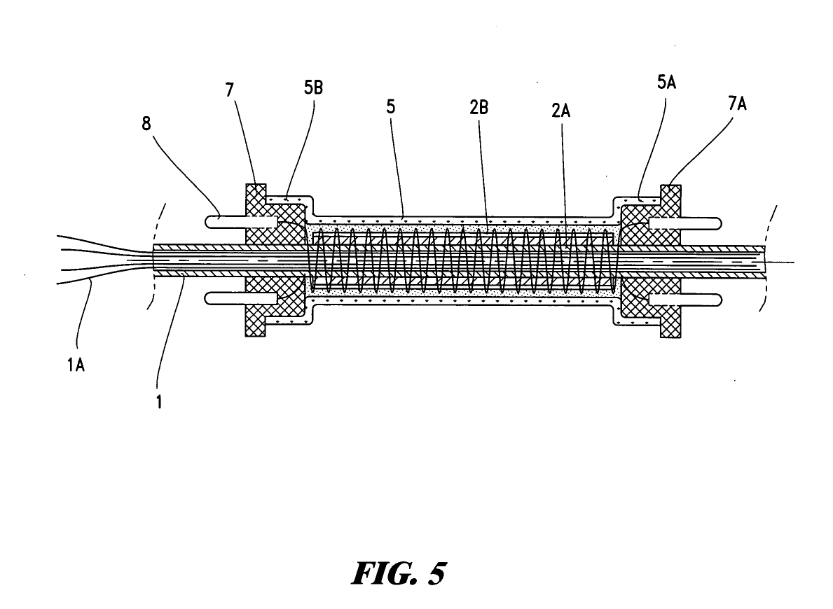

In another preferred embodiment in accordance with the present invention, as shown in FIG. 5, the electrode wire 1 can be tubular conductive body and the tube within the conductive body is mounted across with heat dissipation aluminum coil 1A or copper coil (or connected to a cooling system), extending to connect to a lamp to form a heat dissipation for a high power lamp.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

I claimed:

1. A semiconductor lamp comprising
an electrode wire which is a conductive copper material wire;
a light-emitting base having two circular layers coated in sequence on the outer ring of the electrode wire, with an inner layer formed from material selected from the group consisting Of SiO₂, Al₂O₃, or TiO₂, and an outer layer formed from material selected from the group consisting of gallic phosphate, g8lic arsenide. Indium phosphate third and forth family compounds;
an electrode solenoid which is made from a conductive copper material wire and is spiral shape for mounted onto the outer ring of the light-emitting base to form a light-emitting main body;
a glass tube which is a glass housing having two lateral opening provided with an outwardly extended circular seats for the light-emitting body to mount the inner diameter of the glass tube;
a silicon rubber layer being a transparent silicon rubber adhesive or with fluorescent powder silicon rubber adhesive for filing the gap between the light-emitting body and the glass tube;
two isolated socket having stepped circular seat body and having two conductive rods correspondingly mounted on the larger diameter face of the socket and the smaller diameter face of the socket is for the mounting of a glass tube circular seat, and the circular diameter face is provided with two through hole for the passage of the electrode wire and the electrode solenoid to connect to the two conductive rod;
wherein the outer rim of the electrode wire is in sequence covered with semiconductor light-emitting base material and the outer layer is screwed with electrode solenoid passed through electromagnet exited light-emitting base material, so as to excite semiconductor to generate laser light.

2. The semiconductor lamp as set forth in claim 1, wherein the silicon rubber layer with fluorescent powder is added to provide colored light source or color change effects.

3. The semiconductor lamp of claim 1, wherein the electrode wire is tubular conductive body.
